(19) United States
(12) Patent Application Publication
(10) Pub. No.: US 2013/0060407 A1
(43) Pub. Date: Mar. 7, 2013

(54) CONTROL METHOD OF HYBRID VEHICLE

(71) Applicant: Jae Sung BANG, Yongin (KR)

(72) Inventor: Jae Sung BANG, Yongin (KR)

(73) Assignee: HYUNDAI MOTOR COMPANY, Seoul (KR)

(21) Appl. No.: 13/338,906

(22) Filed: Dec. 28, 2011

(30) Foreign Application Priority Data
Sep. 6, 2011 (KR) 10-2011-0090312

(51) Int. Cl. B60W 10/04; B60W 20/00; H02P 6/16

(52) U.S. Cl. 701/22; 318/400.04; 180/65.265

(57) ABSTRACT

A hybrid control system and method includes an offset candidate value determination step wherein an offset candidate value of a resolver is determined based on predetermined data; a zero current control step wherein all currents are controlled at zero; a voltage detection step wherein the voltage generated in the drive motor is detected while the currents are controlled at zero; an average value calculation step wherein the average value of the voltage is calculated using the detected voltage values; and a final offset value calculation step wherein the final offset valve is calculated using the average value and the offset candidate value. As such, a final offset value is quickly and accurately calculated.

### CROSS-REFERENCE TO RELATED APPLICATION

This application claims priority to and the benefit of Korean Patent Application No. 10-2011-0090312 filed in the Korean Intellectual Property Office on Sep. 6, 2011, the entire contents of which are incorporated herein by reference.

### BACKGROUND OF THE INVENTION

(a) Field of the Invention

The present invention relates to a system and control method of a hybrid vehicle that powers the vehicle by combining engine output and motor output according to a driving condition, which improves fuel efficiency to reduce the rate of fuel consumption.

(B) Description of the Related Art

Generally, a drive motor is mounted in a hybrid vehicle. The drive motor includes a stator and a rotor, and a resolver is disposed to measure an absolute position of the rotator against the stator.

In particular, the resolver is disposed near the drive motor, and an offset error is generated by the tolerance thereof and values detected by the mechanical/electrical error of an inner coil. However, the absolute position of the rotator/stator of the drive motor is still not accurately measured by the offset error (value).

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and control method of a hybrid vehicle that provides more precise control of a motor, reduces the hybrid vehicle fabrication process time, and further reduces the cost of a vehicle having a resolver.

A hybrid control method according to an exemplary embodiment of the present invention may include an offset candidate value determination step wherein predetermined data is used to determine an offset candidate value of a resolver by detecting a rotation position of a drive motor; a zero current control step wherein all currents are controlled to a zero value; a voltage detection step wherein the voltage generated in the drive motor is detected when the currents are set at zero; an average value calculation step wherein an average value of the voltage in the drive motor is calculated using the voltage values detected in the voltage detection step; and a final offset value calculation step wherein a final offset valve is calculated using the average voltage value and the offset candidate value.

In particular, the offset candidate value is the median of predetermined data in the offset candidate value determination step.

The final offset value is calculated by the below equation 5.

$$α = {\overline{α}}^{*} - {tan}^{- 1} ( \frac{{\overline{v}}_{d}}{{\overline{v}}_{q}} ) , \qquad Equation ( 5 )$$

Here, α=final offset value, α̅*=median of offset candidate value, V̅_{d}=average voltage value of axis d (“direct axis”), V̅_{q}=average voltage value of axis q (“quadrature axis”).

At the zero current control step, the current (I_{d}) at axis d and the current (I_{q}) at axis q are controlled to be 0.

The hybrid control method may further include processes that make the motor/ISG (“integrated starting and generating”) and the engine become directly engaged by a clutch, and prevents the torque from the motor/ISG and the engine from being transmitted into a drive wheel. According to various embodiments, the voltage detection step is performed for a predetermined sampling time. In particular, the voltage value is detected in a predetermined cycle in the sampling time in the average calculation step.

According to an exemplary embodiment of the present invention, a control method for a hybrid vehicle uses a predetermined offset value for a resolver that is disposed within the vehicle so as to detect a rotation position of a drive motor, and voltage value is detected in the drive motor when the drive motor is controlled to a zero current so as to quickly and accurately calculate a final offset value.

### BRIEF DESCRIPTION OF THE DRAWINGS

The drawings illustrate exemplary embodiments of the present invention and are not construed to limit any aspect of the invention.

FIG. 1 is a schematic diagram of a hybrid vehicle according to an exemplary embodiment of the present invention.

FIG. 2 shows equations for controlling a hybrid vehicle according to an exemplary embodiment of the present invention.

FIG. 3 is a graph showing a voltage for controlling a hybrid vehicle according to an exemplary embodiment of the present invention.

FIG. 4 is a flowchart showing a control method of a hybrid vehicle according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Hereinafter, the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Portions having no relation with the description will be omitted in order to explicitly explain the present invention, and the same reference numerals will be used for the same or similar elements throughout the specification.

Also, the size and thickness of each element are arbitrarily shown in the drawings, and the present invention is not necessarily limited thereto, and in the drawings, the thickness of layers, films, panels, regions, etc., are exaggerated for clarity.

It is understood that the term hybrid “vehicle” or “vehicular” or other similar term as used herein is inclusive of all hybrid motor vehicles in general such as passenger automobiles including sports utility vehicles (SUV), buses, trucks, various commercial vehicles, watercraft including a variety of boats and ships, aircraft, and the like, and includes parallel and series hybrid vehicles, semi-electric vehicles, plug-in hybrid electric vehicles, hydrogen-powered hybrid vehicles and other alternative combination type fuel vehicles (e.g. fuels derived from resources other than petroleum). As referred to herein, a hybrid vehicle is a vehicle that has two or more sources of power, for example both gasoline-powered and electric-powered vehicles.

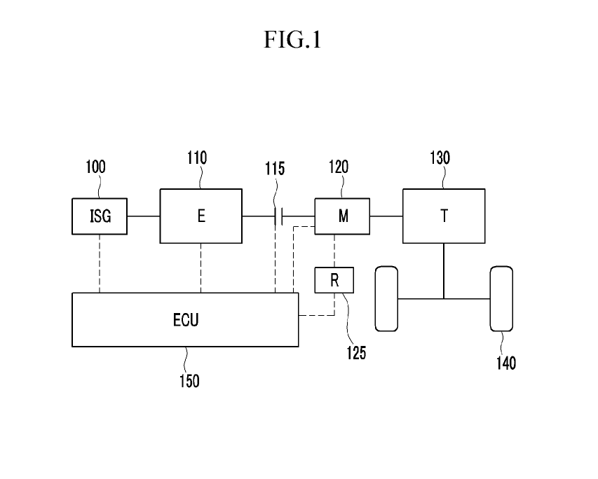

FIG. 1 is a schematic diagram of a hybrid vehicle according to an exemplary embodiment of the present invention.

Referring to FIG. 1, a hybrid vehicle includes a motor/generator (100, ISG: integrated starting and generating), an engine 110, a clutch 115, a drive motor 120, a resolver 125, a transmission 130, a drive wheel 140, and a control portion 150.

The motor/generator 100 starts the engine 110 or generates electricity by the engine 110 to charge a separate a battery (not shown).

The engine 110 is connected to the transmission 130 through the clutch 115 and the drive motor 120 is disposed between the clutch 115 and the transmission 130.

The drive motor 120 assists the output of the engine 110 or inputs a rotation torque to the transmission 130 without operating the engine 110.

The control portion 150 controls the motor/generator 100, the engine 110, the clutch 115, the drive motor 120, and the transmission 130. The general aspects and functions of the control portion 150 are well understood in the art, and can be in accordance with such general aspects and functions and, as such, a detailed description of these aspects and functions of the control portion 150 according to an exemplary embodiment of the present invention will be omitted.

According to an exemplary embodiment, the engine 110 operates when the clutch 115 is engaged, and the engine 110, the motor/generator 100, and the drive motor 120 are all rotated at the same speed. In this condition, the engine 110 is operated in an idle state, while the motor/generator 100 and the drive motor 120 function as a generator by a driving torque of the engine 110.

The resolver 125 detects absolute position of the rotator with respect to the stator in the drive motor 120, transfers the detected position to the control portion 150, and the control portion 150 applies an offset value for an assembly clearance to compensate and provide a more accurate rotation position of the rotator.

In a case that the drive motor 120, the resolver 125, or the motor/generator 100 is replaced or repaired, there is often a problem in compensating the rotation position detected by the resolver 125 near the drive motor 120 with a conventional offset value. Accordingly, the offset value of the resolver 125 is reset.

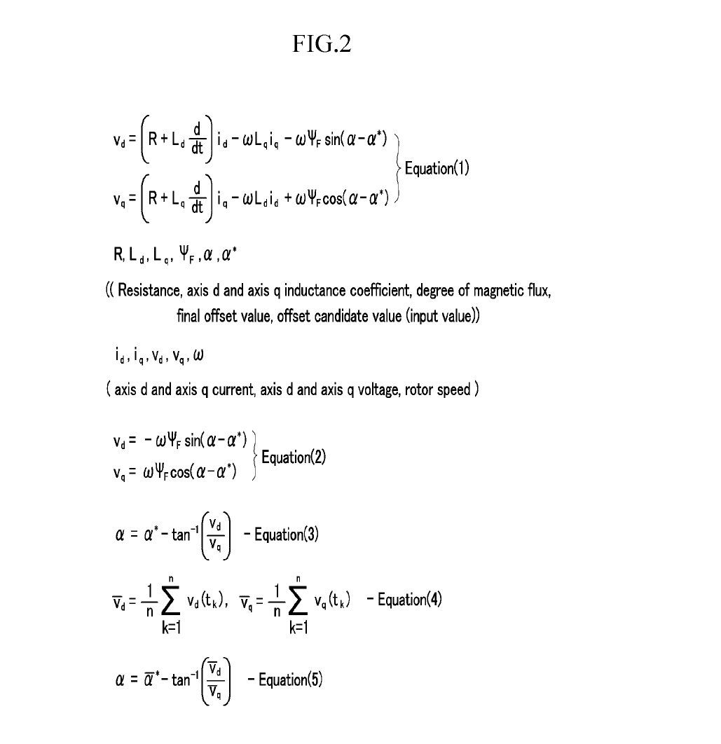

FIG. 2 shows equations for controlling a hybrid vehicle according to an exemplary embodiment of the present invention.

Equation (1) of FIG. 2 is a voltage differential equation that is related to the resolver 125, which is as follows:

$$\begin{matrix}{v}_{d} = ( R + {L}_{d} \frac{d }{d t} ) {i}_{d} - ω {L}_{q} {i}_{q} - ω {Ψ}_{F} sin ( α - {α}^{*} ) \\ {v}_{q} = ( R + {L}_{q} \frac{d }{d t} ) {i}_{q} - ω {L}_{d} {i}_{d} - ω {Ψ}_{F} cos ( α - {α}^{*} )\end{matrix} \} \qquad Equation ( 1 )$$

In this Equation (1), R is a resistance that is applied to the drive motor 120, L_{d} is an axis d inductance coefficient, L_{q} is an axis q inductance coefficient, Ψ_{F} is the size of magnetic flux, α is the final offset value, and α* is the offset candidate value.

Further, in Equation (1), i_{d} is axis d current, i_{q} is axis q current, v_{d} is axis d voltage, v_{q} is axis q voltage, and ω is rotator angle speed.

In Equation (1), if axis d current (i_{d}) and axis q current (i_{q}) converge to 0 through a zero current control, then Equation (1) becomes Equation (2).

$$\begin{matrix}{v}_{d} = - ω {Ψ}_{F} sin ( α - {α}^{*} ) \\ {v}_{q} = ω {Ψ}_{F} cos ( α - {α}^{*} )\end{matrix} \} \qquad Equation ( 2 )$$

From the two equations of Equation (2), Equation (3) is obtained as follows:

$$α = {α}^{*} - {tan}^{- 1} ( \frac{{v}_{d}}{{v}_{q}} ) \qquad Equation ( 3 )$$

Referring to Equation (3), an offset candidate value (α*), axis d voltage (V_{d}), and axis q voltage (V_{q}) are used to calculate an offset value (α).

In particular, the offset candidate value is one value that is selected among the offset candidate values. Because the axis d voltage and the axis q voltage are varied according to a sampling time because of a sensor noise, this is described in further detail as follows.

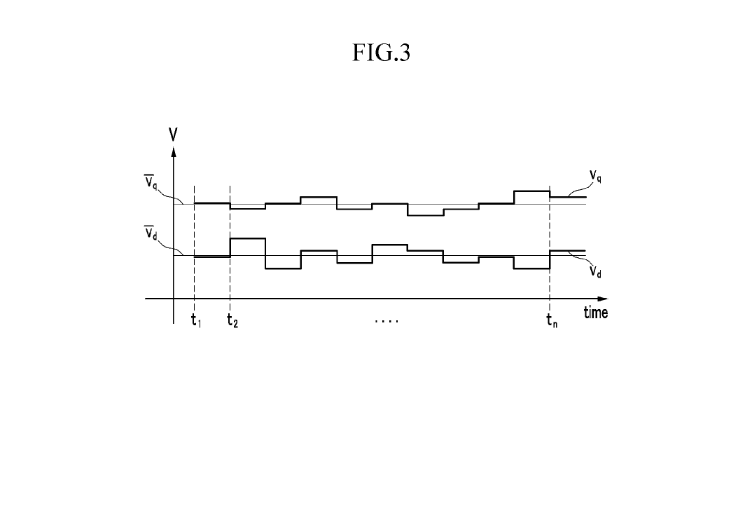

FIG. 3 is a voltage graph with a sensor noise while currents are controlled to zero according to an exemplary embodiment of the present invention.

Firstly, referring to FIG. 3, the horizontal axis represents time and the vertical axis represents voltage.

As shown, axis d voltage (V_{d}) and axis q voltage (V_{q}) are detected in the drive motor 120, and the axis d voltage (V_{d}) and the axis q voltage (V_{q}) are varied depending on time.

Accordingly, the axis d voltage and the axis q voltage are detected for a predetermined time by a predetermined cycle, and the average value thereof is used.

In the below Equation (4), an average value of the axis d voltage is used to calculate an axis d voltage average value ( V̅_{d}), and an average value of the axis q voltage is used to calculate an axis q voltage average value ( V̅_{q}).

$${\overline{v}}_{d} = \frac{1}{n} {\sum }_{k = 1}^{n} {v}_{d} ( {t}_{k} ) , \\ {\overline{v}}_{q} = \frac{1}{n} {\sum }_{k = 1}^{n} {v}_{q} ( {t}_{k} ) \qquad Equation ( 4 )$$

Accordingly, if Equation (4) is applied to Equation (3), Equation (5) is provided.

$$α = {\overline{α}}^{*} - {tan}^{- 1} ( \frac{{\overline{v}}_{d}}{{\overline{v}}_{q}} ) \qquad Equation ( 5 )$$

Accordingly, median values of ( α̅*) the offset candidate value, the axis d voltage average value ( V̅_{d}), and the axis q voltage average value ( V̅_{q}) are applied to Equation 5 to quickly calculate the offset value (α). The thus calculated offset value is transferred to the control portion 150, and the value is used to compensate the absolute position of a rotator of the drive motor 120.

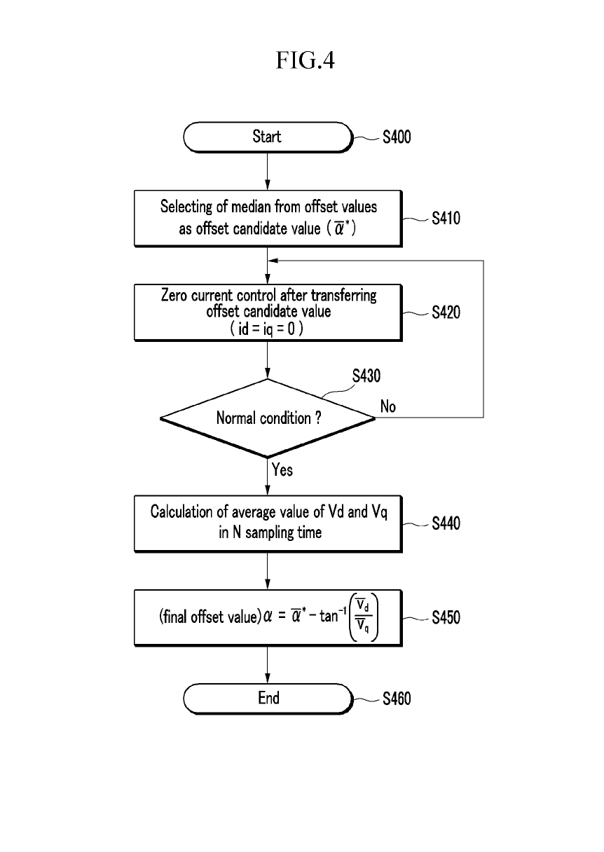

FIG. 4 is a flowchart showing a control method of a hybrid vehicle according to an exemplary embodiment of the present invention.

In particular, referring to FIG. 4, at S400, a control for compensating the signal detected by the resolver 125 starts.

At S410, a median of offset values is selected as an offset candidate value. For example, if the offset values range from 1 to a maximum value of 10, the median thereof might be, for example, 5.5.

After the offset candidate value is selected in a S420, the drive motor 120 is current controlled to zero current. Here, an axis d current and an axis q current of the drive motor 120 are controlled to be 0 through use of a current controller.

At S430, it is determined whether an operating condition is normal. The normal condition in an exemplary embodiment of the present invention signifies that the axis d current and the axis q current of the drive motor 120 are 0.

Further, the engine 110 is operated in an idle condition and the drive motor 120 is operated by the engine 110 through the clutch 115. Also, the transmission 130 separates an input shaft from an output shaft, and a torque is not transferred to a drive wheel 140 to provide a parking condition (P).

At S440, each average value of N number of axis d voltages and N number of axis q voltages is calculated during a predetermined sampling period, and a median of the offset candidate value ( α̅*), the axis d voltage average value ( V̅_{d}), and the axis q voltage average value ( V̅_{q}) are applied to Equation (5) to calculate a final offset value (α) at S450.

The final offset value that is calculated is transmitted to the control portion 150, and the controller 150 compensates the signals detected in the resolver 125.

according to an exemplary embodiment of the present invention, a median is selected in the offset candidate values, but in other embodiments an average value can be applied to calculate the final offset value.

Furthermore, the above described processes and methods may be performed by control logic embodied as computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

100: motor/generator
110: engine
115: clutch
120: drive motor
125: resolver
130: transmission
140: drive wheel
150: control portion

What is claimed is:

1. A hybrid control method, comprising:
an offset candidate value determination step wherein an offset candidate value of a resolver for detecting a rotation position of a drive motor is determined based on predetermined data;
a zero current control step wherein all currents are controlled to be zero;
a voltage detection step wherein voltage generated in the drive motor is detected while all currents are zero;
an average value calculation step wherein an average value of voltage is calculated using the detected voltage values in the voltage detection step; and
a final offset value calculation step wherein the final offset valve is calculated using the average value of the voltage and the offset candidate value.

2. The hybrid control method of claim 1, wherein the offset candidate value is a median of the predetermined data in the offset candidate value determination step.

3. The hybrid control method of claim 1, wherein the offset candidate value is an average value of the predetermined data in the offset candidate determination step.

4. The hybrid control method of claim 1, wherein the final offset value is calculated by Equation 5.
$$α = {\overline{α}}^{*} - {tan}^{- 1} ( \frac{{\overline{v}}_{d}}{{\overline{v}}_{q}} ) , \qquad Equation ( 5 )$$
wherein α=final offset value, α̅*=median of offset candidate value, V̅_{d}=average voltage value of axis d, V̅_{q}=average voltage value of axis q.

5. The hybrid control method of claim 1, wherein the zero current control step further controls the drive motor, axis d current (I_{d}) and axis q current (I_{q}) that are generated in the drive motor to be 0.

6. The hybrid control method of claim 1, further comprising: controlling a torque of the engine or the drive motor to not transfer a drive wheel, and controlling the drive motor to be rotated by the engine.

7. The hybrid control method of claim 1, wherein the voltage detection step is performed for a predetermined sampling time.

8. The hybrid control method of claim 7, wherein the voltage value is detected in a predetermined cycle in the sampling time in the average calculation step.

9. A system comprising:
a drive motor;
a resolver configured to detect rotation position of the drive motor; and
a control unit configured to determine an offset candidate value of the resolver based on predetermined data, control all currents to be zero, detect voltage generated in the drive motor while all currents are zero, calculate an average value of voltage using the detected voltage, and calculate a final offset valve using the average value of the voltage and the offset candidate value.

10. A computer readable medium containing executable program instructions executed by a controller, comprising:
program instructions that determine an offset candidate value of a resolver based on predetermined data;
program instructions that control all currents to be zero, and
program instructions that detect voltage generated in a drive motor while all currents are zero;
program instructions that calculate an average value of voltage using the detected voltage; and
program instructions that calculate a final offset valve using the average value of the voltage and the offset candidate value.
